(19) United States
(12) Patent Application Publication
(10) Pub. No.: US 2009/0315842 A1
(43) Pub. Date: Dec. 24, 2009

(54) Method and Related Interface for Controlling an Electronic Device with a Touch Panel

(76) Inventors: Hsin-Yuan Peng, Taipei Hsien (TW); Shu-Hung Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/396,493

(22) Filed: Mar. 3, 2009

(30) Foreign Application Priority Data
Jun. 19, 2008 (TW) 097122871

(51) Int. Cl. G06F 3/041; G06F 3/033

(52) U.S. Cl. 345/173; 345/179

(57) ABSTRACT

A method for controlling an electronic device with a touch panel includes displaying a background picture on the touch panel, displaying a plurality of selecting objects corresponding to a plurality of functions of the electronic device on the background picture, displaying a zooming scroll on a position of the touch panel, controlling a number of the plurality of selecting objects simultaneously displayed on the touch panel by zooming in or out via the zooming scroll, and controlling the electronic device to execute a function corresponding to a selecting object of the plurality of selecting objects when the selecting object is clicked.

### BACKGROUND OF THE INVENTION

1. Field of the Invention

The present invention is related to a method and related interface for controlling an electronic device with a touch panel, and more particularly, to a method and related control interface of a menu of compact hierarchy.

2. Description of the Prior Art

Inside many electronic devices, like personal digital assistant (PDA), a touch panel is often used as the primary input device, and a user can use a touch pen or a finger to select a selecting object to execute a program or application software. However, these selecting objects are usually exhibited in a matrix format, causing the limited number of the selecting objects in a picture. In addition, the interface is too monotonous to have an independent character for personalized design. Meanwhile, because the menu comprises a hierarchy with too many tiers such that sometimes to find a specific function becomes a difficult and tedious procedure, and the user convenience is decreased.

For example, please refer to FIG. 1A to 1D. FIG. 1A to 1D illustrate schematic diagrams of operations of a PDA phone 10 according to the prior art. When a user plays music via the PDA phone 10, first, as shown in FIG. 1A, the user needs to click a “START” menu. Next, as shown in FIG. 1B, click “PROGRAM” in the “START” menu. Then, as shown in FIG. 1C, click a scroll in “PROGRAM” to display “PLAY MUSIC”. At last, as shown in FIG. 1D, click “PLAY MUSIC” to open a music playing program to play the music.

As can be known from the above, according to the prior art, the control interface via the touch panel is lack of personalized design, the user cannot change the position of the main menu, and it is also hard to find specific functions owing to too many tiers in the menu hierarchy. Besides that, the information shown in the PDA phone 10 is seldom related to the user's environment directly, and to make a personalized menu becomes impossible.

### SUMMARY OF THE INVENTION

It is therefore a primary objective of the present invention to provide the control method of an electronic device with a touch panel and the related control interface.

An embodiment of the invention discloses a method for controlling an electronic device with a touch panel, which comprises displaying a background picture on the touch panel, displaying a plurality of selecting objects corresponding to a plurality of functions of the electronic device on the background picture, displaying a zooming scroll on a position of the touch panel, controlling a number of the plurality of selecting objects simultaneously displayed on the touch panel by zooming in or out via the zooming scroll, and controlling the electronic device to execute a function corresponding to a selecting object of the plurality of selecting objects when the selecting object is clicked.

An embodiment of the invention discloses a control interface of an electronic device with a touch panel, which comprises a background picture displayed on the touch panel, a plurality of selecting objects displayed on the background picture, corresponding to a plurality of functions of the electronic device, and a zooming scroll displayed on a fixed position on the touch panel, for controlling a number of the plurality of selecting objects simultaneously displayed on the touch panel by zooming in or out.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A to 1D illustrate schematic diagrams of operations of a PDA phone according to the prior art.

FIG. 2 illustrates a schematic diagram of a control process according to an embodiment of the invention.

FIG. 3A illustrates a schematic diagram of a control interface according to an embodiment of the invention.

FIG. 3B illustrates a function table corresponding to every selecting object of the control interface shown in FIG. 3A.

FIG. 4 to 12 illustrate operations of the control process shown in FIG. 3A.

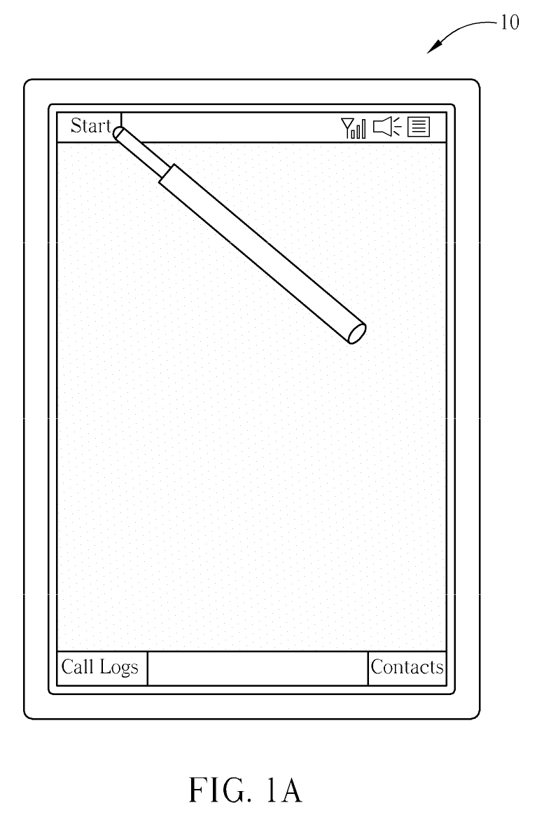

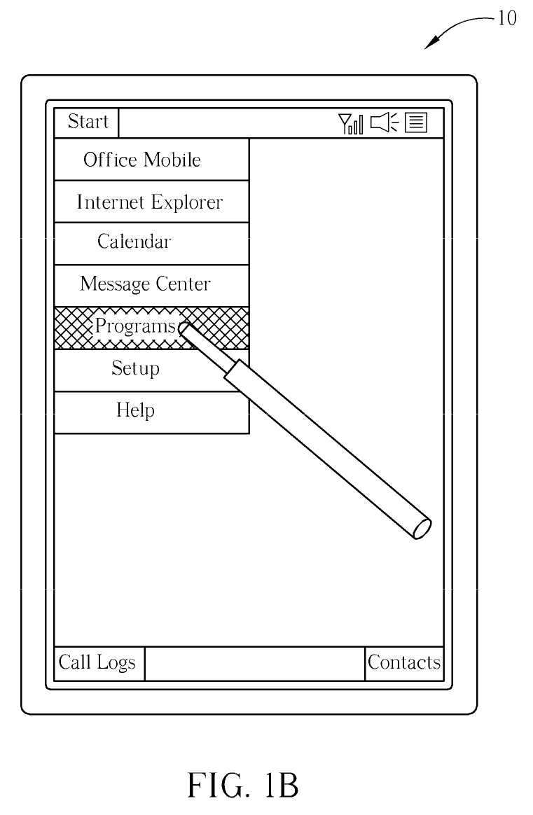

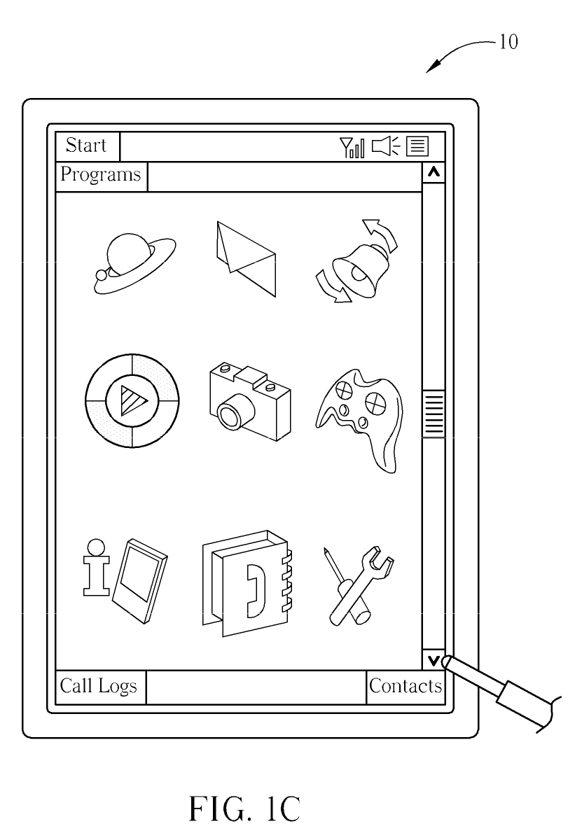

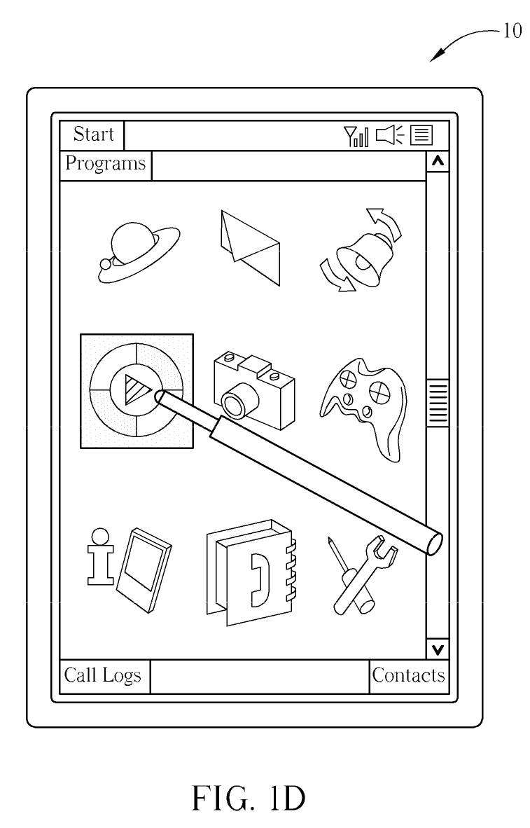

### DETAILED DESCRIPTION

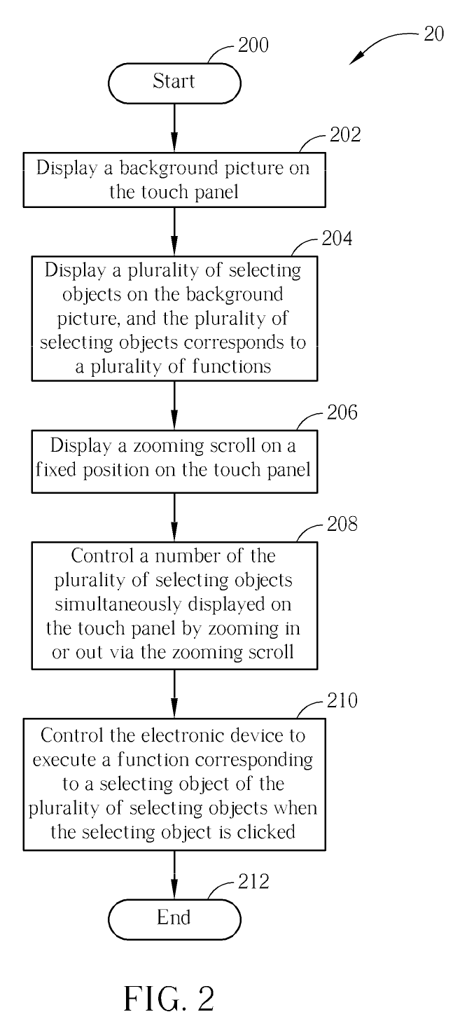

Please refer to FIG. 2. FIG. 2 illustrates a schematic diagram of a control process 20 according to an embodiment of the invention. The control process 20 is used in an electronic device with a touch panel, like PDA, and comprises the following steps:

STEP 200: Start.

STEP 202: Display a background picture on the touch panel.

STEP 204: Display a plurality of selecting objects on the background picture, and the plurality of selecting objects corresponds to a plurality of functions.

STEP 206: Display a zooming scroll on a fixed position on the touch panel.

STEP 208: Control a number of the plurality of selecting objects simultaneously displayed on the touch panel by zooming in or out via the zooming scroll.

STEP 210: Control the electronic device to execute a function corresponding to a selecting object of the plurality of selecting objects when the selecting object is clicked.

STEP 212: End.

According to the control process 20, the invention displays a plurality of selecting objects on the background picture, and controls the number of the plurality of selecting objects simultaneously displayed on the touch panel by zooming in or out via the zooming scroll, such that the user can make a fast selection to a specific selecting object to execute the corresponding function. Simply speaking, the invention can display the selecting objects corresponding to the different functions on the touch panel. Via the zooming scroll, the invention can control the number of the selecting objects simultaneously displayed on the touch panel, so as to decrease the number of operating tiers, and facilitate the user to execute specific functions.

Note that, the control process 20 is an embodiment of the invention, and those skilled in the art will readily observe that numerous modifications and alterations may be made while retaining the teachings of the invention. For example, the background picture, the selecting object, and the zooming scroll are not restricted to any specific color, size, quantity . . . etc., and can be used to form a browsing interface similar to an electronic map (more details stated as follows) or other operational graphic interface. Besides that, the invention can add graphic buttons in fixed positions on the touch panel, like “Main Menu”, “Favorite”, “Home”. . . etc., to make a fast selection of a selecting object among the plurality of selecting objects. For indicating a region of a current screen, a display control window can be added in a fixed position on the touch panel to indicate the position and the size of the current screen relative to the background picture. Certainly, the user can use a finger, a touch pen or other relevant object to move on the touch panel in a specific direction to move the current screen.

According to the invention, the selecting object is displayed on the background picture, the user can exchange the positions of the selecting objects by means of dragging a selecting object upon another. In otherwords, the user can define the positions of the selecting objects on the background picture to satisfy personalized demand. Therefore, through the use of the invention, the selecting objects corresponding to different functions can display on the touch panel simultaneously. The user can adjust the number, the positions and the sizes of the selecting objects simultaneously displayed on the touch panel by using a zooming scroll, a display control window or a moving action on the touch panel. Also, the user can change positions of the selecting objects for achieving the personalized objective.

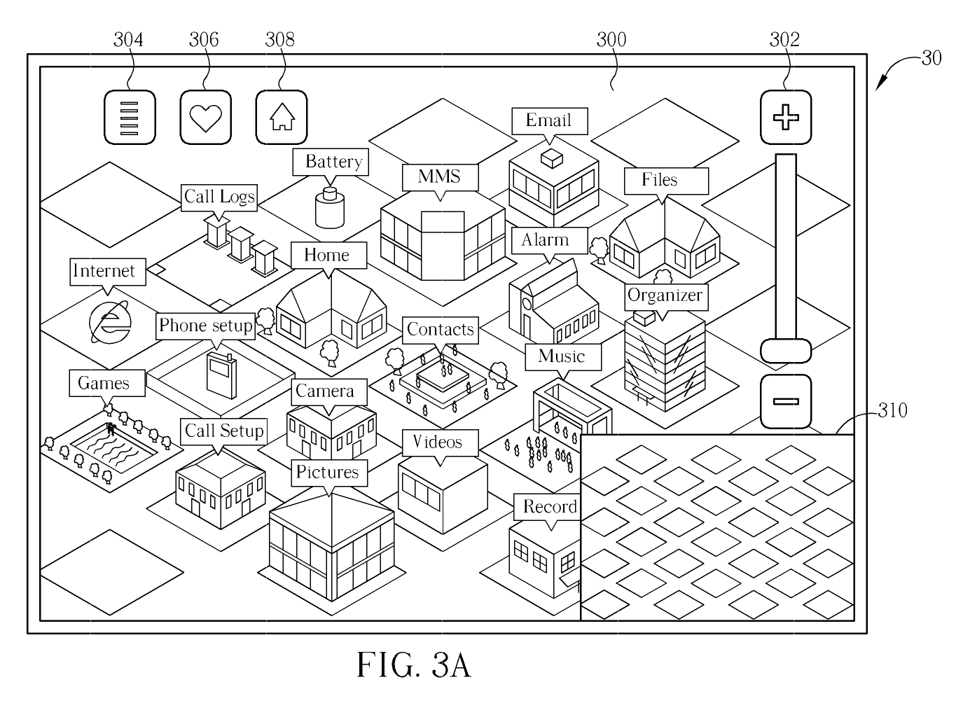

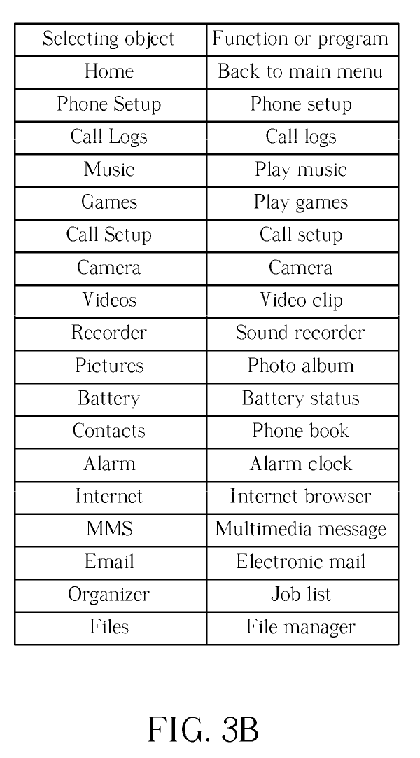

To clearly explain the operations of the control process 20, please refer to FIG. 3A and FIG. 3B. FIG. 3A illustrates a schematic diagram of a control interface 30 according to an embodiment of the invention. FIG. 3B illustrates a function table corresponding to every selecting object of the control interface 30. The control interface 30 is realized according to the control process 20, and is similar to a browsing interface of an electronic map. The control interface 30 is preferably a PDA phone, which comprises a background picture 300, a zooming scroll 302, buttons 304, 306, 308, a display control window 310 and selecting objects, like “Home”, “Phone Setup”, “Call Logs”, . . . etc.

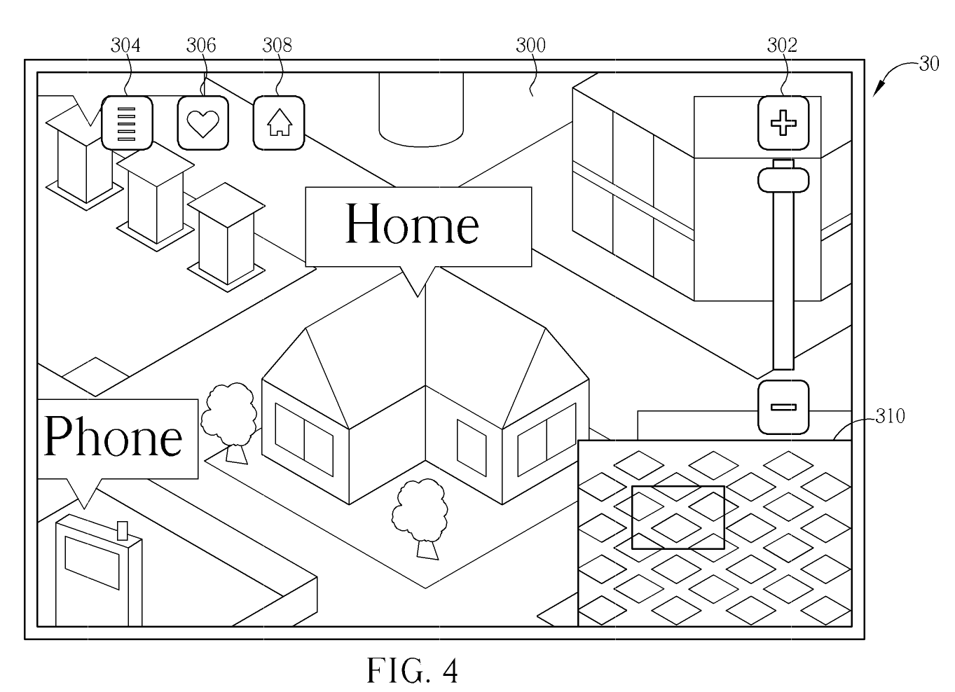

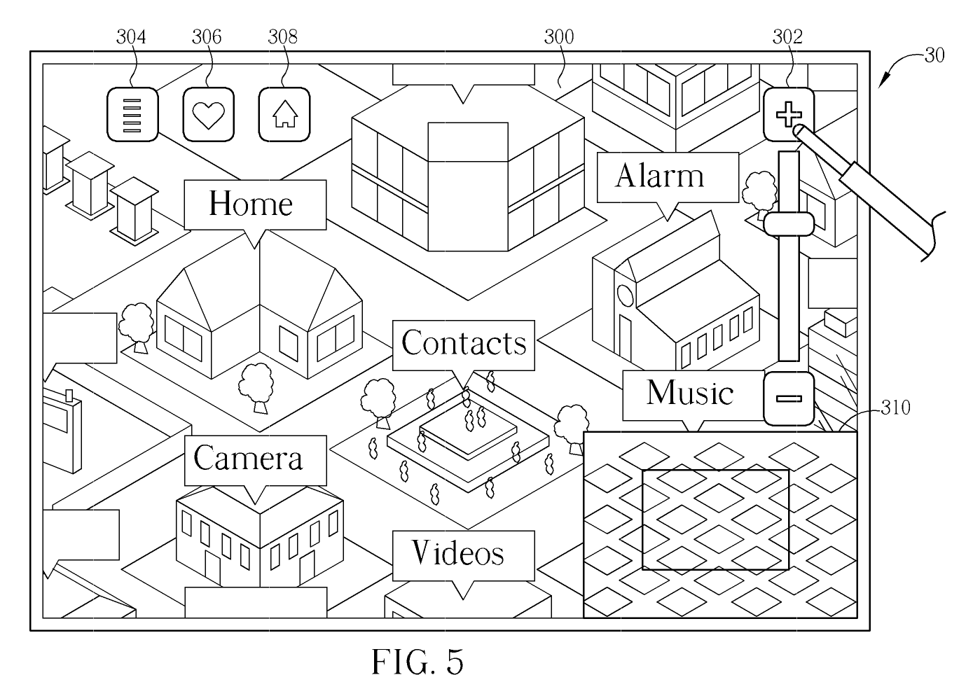

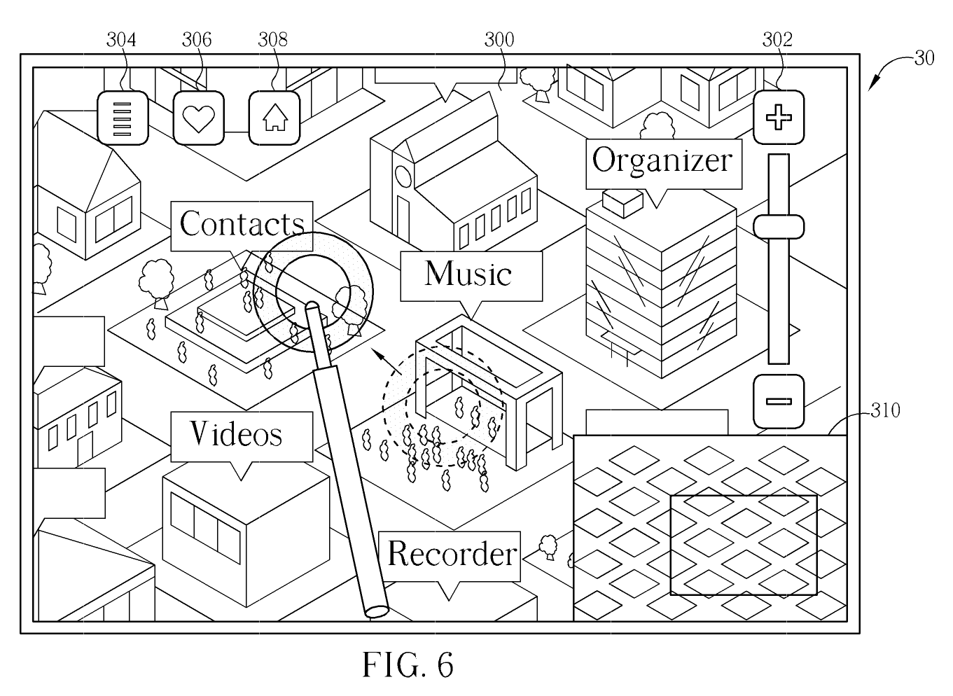

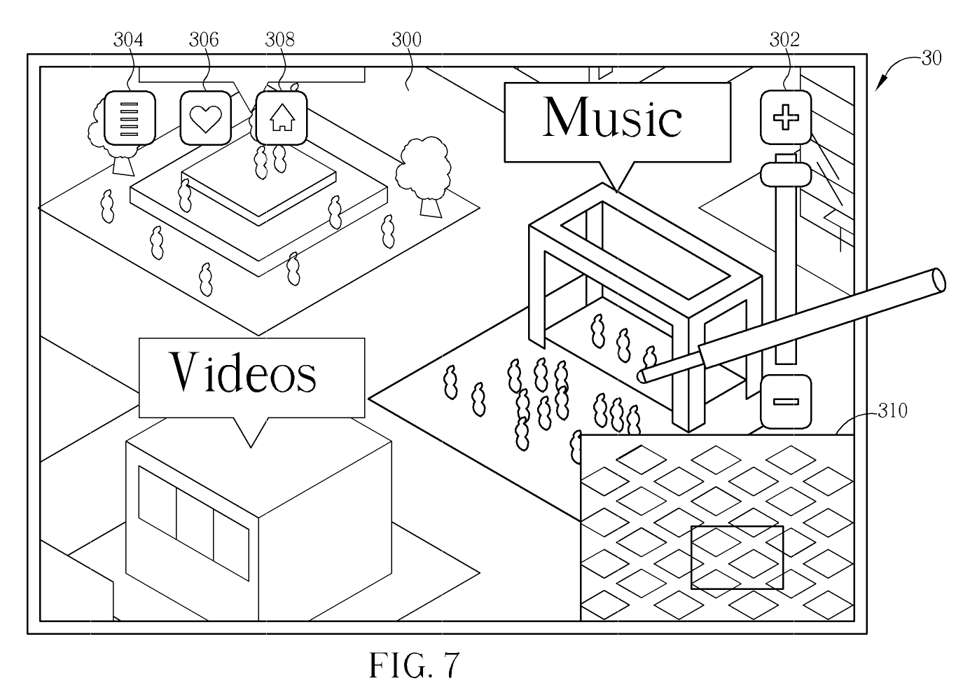

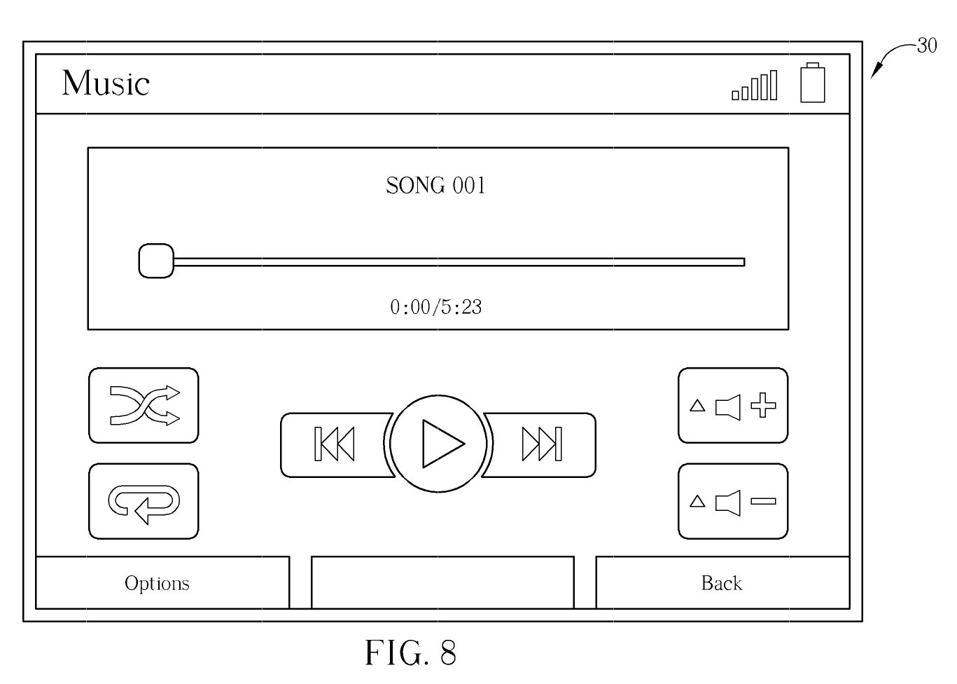

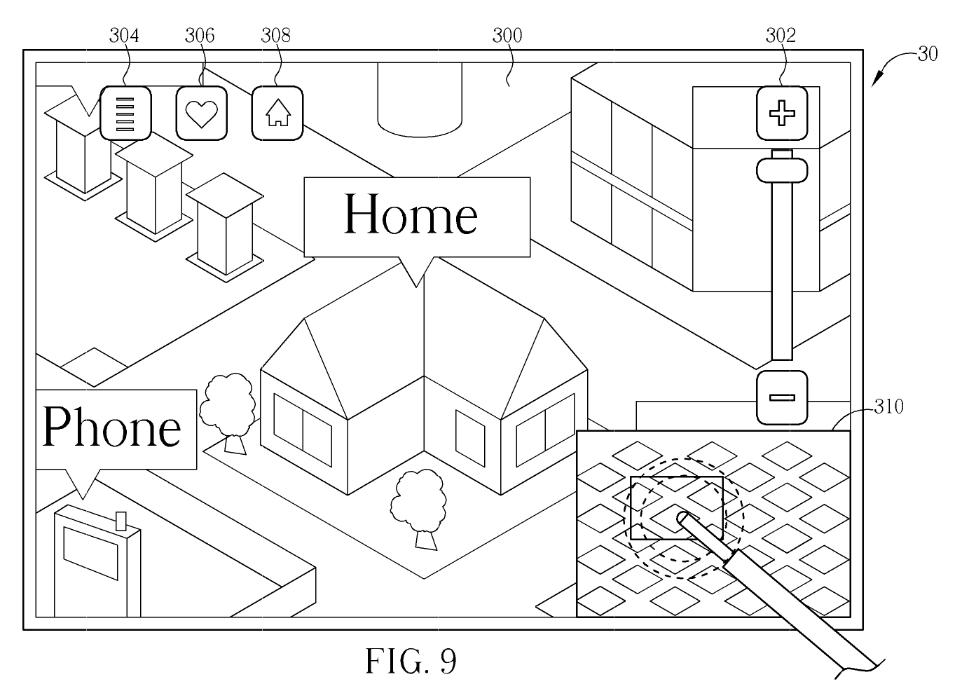

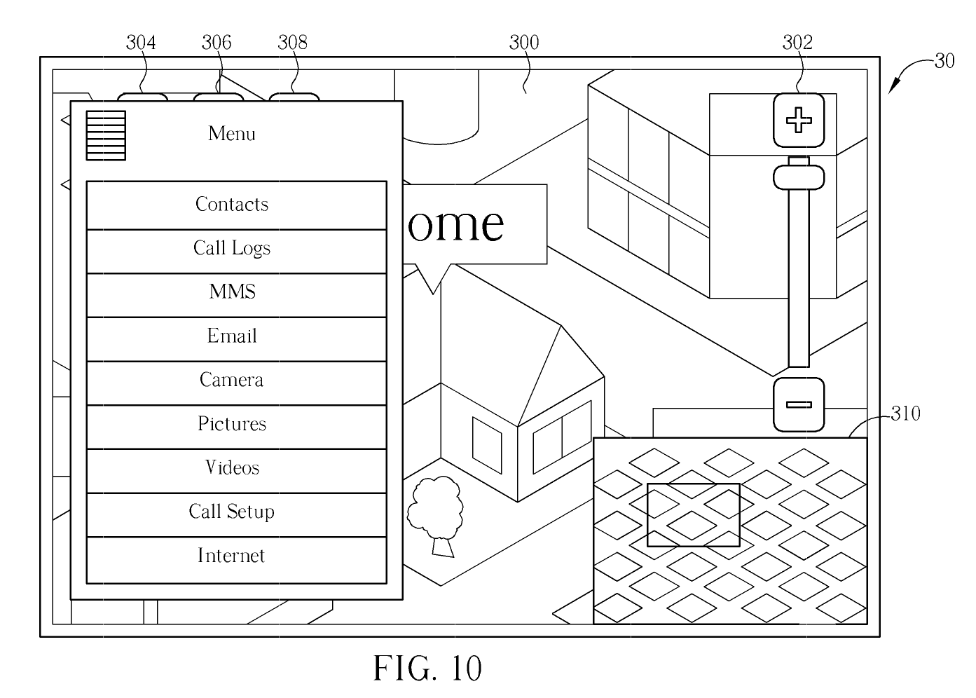

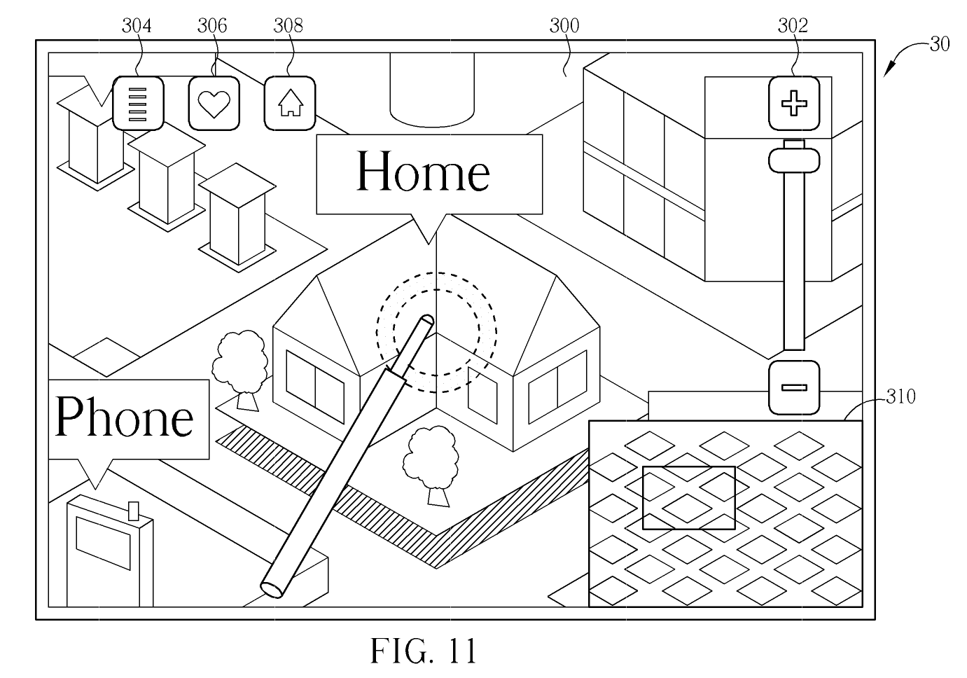

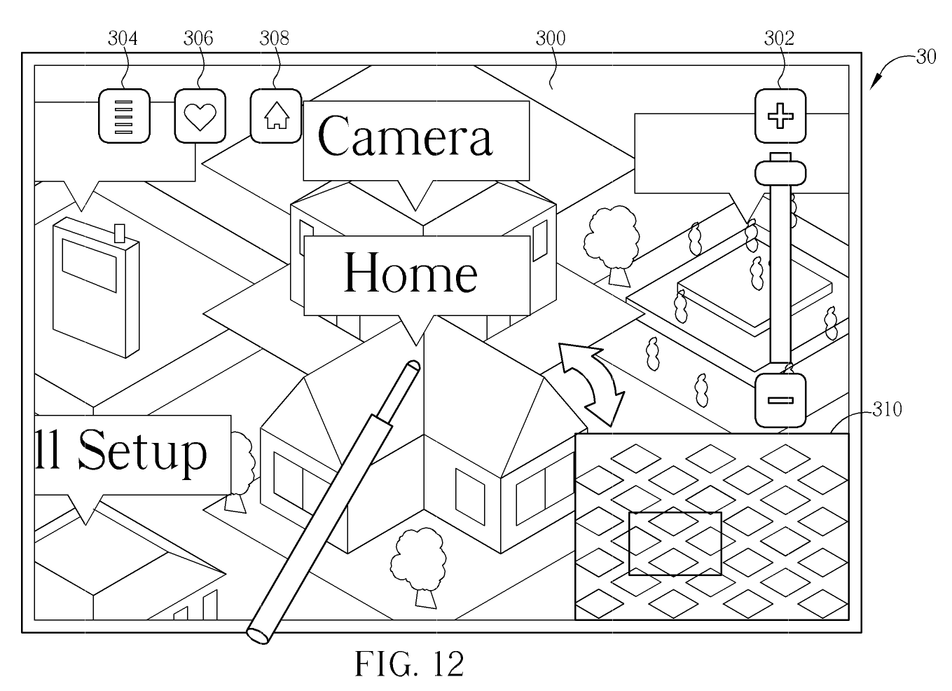

Next, please refer to FIG. 4 to 12, which are used to illustrate operations of the control process 30. First, in FIG. 4, when the user initiates the control interface 30 for the first time, the control interface 30 will display the enlarged selecting object “Home”. At this time, the user can change the number of the selecting objects of the current screen by clicking the zooming scroll 302 (as illustrated in FIG. 5), or moving the region of the current screen by means of sliding (as illustrated in FIG. 6), so as to display the selecting objects corresponding to the specific functions (like selecting objects “Music”). Therefore, as illustrated in FIG. 7, the user can select the demanded selecting object “Music”, and the electronic device will execute the corresponding music playing function (as illustrated in FIG. 8). Of course, the user can move the region of the current screen to display all the demanded selecting objects by using the display control window 310 as shown in FIG. 9. Besides, the buttons 304, 306, and 308 are corresponding to functions “Main Menu”, “Favorite” and “Home”, respectively, and are used for making fast selection to specific selecting object. Taking FIG. 10 as an example, the user can make fast selection to specific selecting objects, like “Contacts”, “Call Logs”, . . . etc., via the button 304. Of course, the user can adjust the selecting objects corresponding to the buttons 304, 306, and 308, or add other buttons (like “Recycled Bottle”, corresponding to those selecting objects not displayed), which is not restricted. On the other hand, as illustrated in FIG. 11 and FIG. 12, the user can click on a specific selecting object (like selecting object “Home”, in this example) and drag upon the other selecting object (like selecting object “Camera”) to exchange their positions.

FIG. 4 to FIG. 12 are used to explain the operations of the control interface 30, and those skilled in the art will readily observe that numerous modifications and alterations may be made while retaining the teachings of the invention. For example, when there is a phone calling, the invention can use a specific dialog box to display the event, and when the battery is low, a selecting object “Battery” transforms itself into a plug logo, or alternatively, a picture or a text. Besides that, the control interface 30 can also change the display mode based on the system clock of the electronic device, or the weather condition (by a built-in thermometer or real-time weather information via network); for example, displaying sun logo in the daytime, displaying moon logo in the night, displaying raindrop logo when it rains, etc.

Therefore, via the invention, the selecting objects corresponding to different functions can be displayed on the touch panel simultaneously. The user can adjust the number, the positions and the sizes of the selecting objects simultaneously displayed on the touch panel via the zooming scroll, the display control window or the moving action. In the same time, the user can change the position of the selecting object by user's own will, such that the design goal of user personalization can be achieved. Also, an interesting and practical control interface is built by connecting the environmental status.

Those skilled in the art will readily observe that numerous modifications and alterations of the device and method may be made while retaining the teachings of the invention.

What is claimed is:

1. A method for controlling an electronic device with a touch panel comprising:
displaying a background picture on the touch panel;
displaying a plurality of selecting objects corresponding to a plurality of functions of the electronic device on the background picture;
displaying a zooming scroll on a position of the touch panel;
controlling a number of the plurality of selecting objects simultaneously displayed on the touch panel by zooming in or out via the zooming scroll; and
controlling the electronic device to execute a function corresponding to a selecting object of the plurality of selecting objects when the selecting object is clicked.

2. The method of claim 1 further comprising displaying a button on another position of the touch panel for rapidly selecting a specific selecting object of the plurality of the selecting objects.

3. The method of claim 1 further comprising displaying a display control window on another position of the touch panel for indicating a position and a size of a current screen relative to the background picture of the touch panel.

4. The method of claim 3 further comprising controlling the position of the current screen relative to the background picture via the display control window.

5. The method of claim 1, wherein a current screen of the touch panel is moved along a first direction when an object moves in the first direction on the touch panel.

6. The method of claim 1, wherein a position of a first selecting object of the plurality of the selecting objects is exchanged with a position of a second selecting object when the first selecting object is dragged upon the second selecting object.

7. The method of claim 1, wherein the electronic device is a Personal Digital Assistant (PDA) phone.

8. A control interface of an electronic device with a touch panel comprising:
a background picture displayed on the touch panel;
a plurality of selecting objects displayed on the background picture, corresponding to a plurality of functions of the electronic device; and
a zooming scroll displayed on a position of the touch panel, for controlling a number of the plurality of selecting objects simultaneously displayed on the touch panel by zooming in or out.

9. The interface of claim 8 further comprising a button displayed on another position of the touch panel, for rapidly selecting a specific selecting object in the plurality of the selecting objects.

10. The interface of claim 8 further comprising a display control window displayed on another position of the touch panel for indicating a position and a size of a current screen relative to the background picture of the touch panel.

11. The interface of claim 10, wherein the display control window is further utilized for controlling the position of the current screen relative to the background picture.

12. The interface of claim 8, wherein a current screen of the touch panel is moved along a first direction when an object moves in the first direction on the touch panel.

13. The interface of claim 8, wherein the electronic device executes a function corresponding to a selecting object of the plurality of the selecting objects when the selecting object is selected.

14. The interface of claim 8, wherein a position of a first selecting object of the plurality of the selecting objects is exchanged with a position of a second selecting object when the first selecting object is dragged upon the second selecting object.

15. The interface of claim 8, wherein the electronic device is a Personal Digital Assistant (PDA) phone.
